(19) United States
(12) Patent Application Publication
(10) Pub. No.: US 2019/0343110 A1
(43) Pub. Date: Nov. 14, 2019

(54) INFLATABLE HUNTING DECOY ASSEMBLY

(71) Applicant: John Munno, Huntington Station, NY (US)

(72) Inventor: John Munno, Huntington Station, NY (US)

(21) Appl. No.: 15/976,549

(22) Filed: May 10, 2018

(51) Int. Cl. A01M 31/06; F41H 3/02

(52) U.S. Cl. CPC A01M 31/06; F41H 3/02

(57) ABSTRACT

An inflatable hunting decoy assembly for conditioning game to the appearance of a hunter in a tree stand includes a tree stand that is positionable in a tree for hunting. A decoy is positionable in the tree stand. The decoy is structured to resemble a hunter in a tree stand thereby facilitating game proximate the tree stand to become accustomed to the sight of a human in the tree stand. A garment is worn on the decoy and the garment is comprised of camouflaged material to give the decoy the ornamental appearance of a hunter.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to decoy devices and more particularly pertains to a new decoy device for conditioning game to the appearance of a hunter in a tree stand.

### BRIEF SUMMARY OF THE INVENTION

An embodiment of the disclosure meets the needs presented above by generally comprising a tree stand that is positionable in a tree for hunting. A decoy is positionable in the tree stand. The decoy is structured to resemble a hunter in a tree stand thereby facilitating game proximate the tree stand to become accustomed to the sight of a human in the tree stand. A garment is worn on the decoy and the garment is comprised of camouflaged material to give the decoy the ornamental appearance of a hunter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an inflatable hunting decoy assembly according to an embodiment of the disclosure.

FIG. 2 is a left side view of an embodiment of the disclosure.

FIG. 3 is a perspective in-use view of an embodiment of the disclosure.

FIG. 4 is a perspective vive of a garment of an embodiment of the disclosure.

### DETAILED DESCRIPTION OF THE INVENTION

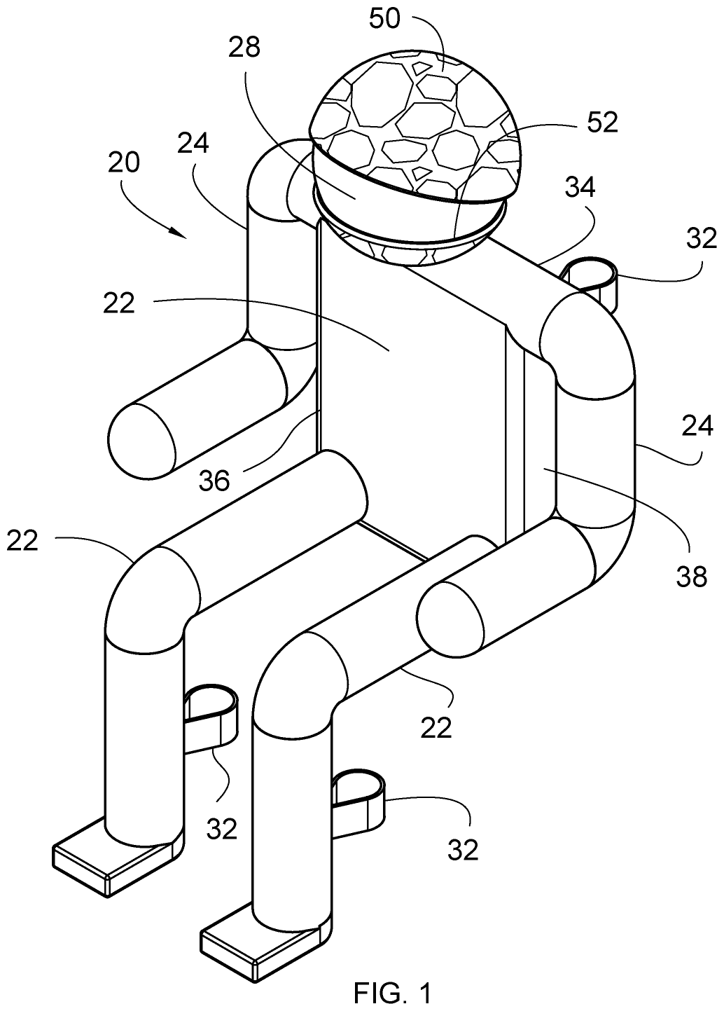

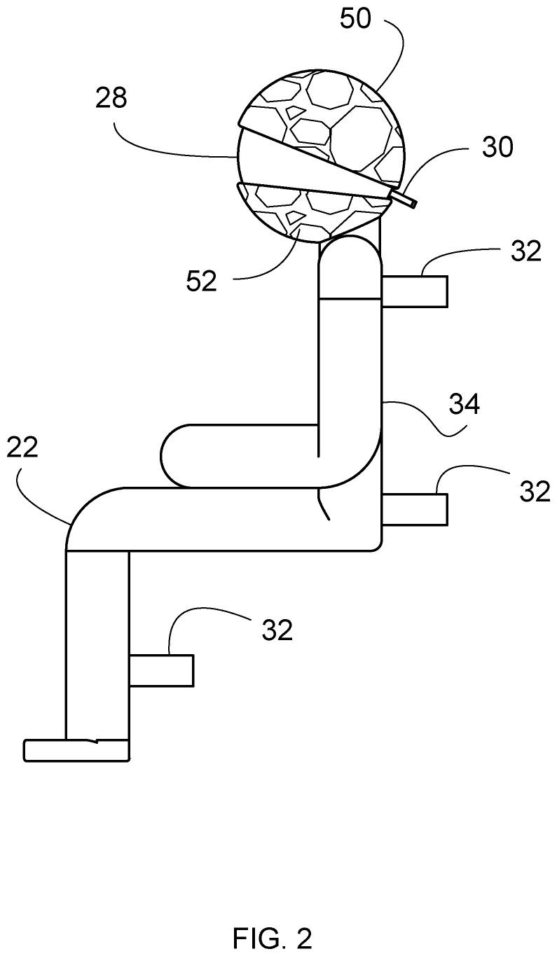

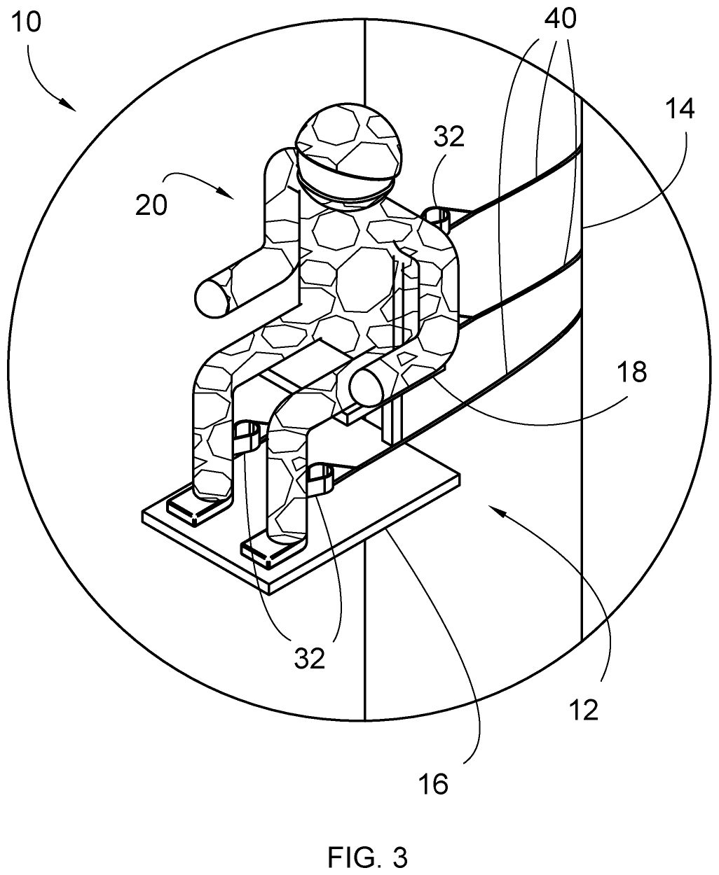

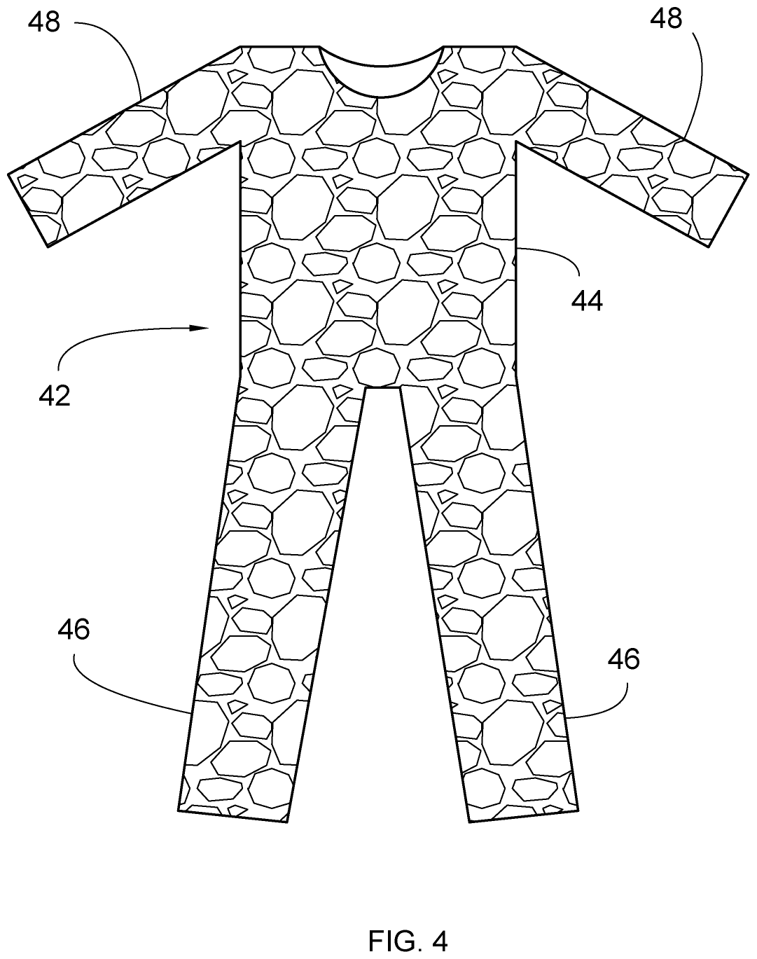

With reference now to the drawings, and in particular to FIGS. 1 through 4 thereof, a new decoy device embodying the principles and concepts of an embodiment of the disclosure and generally designated by the reference numeral 10 will be described.

As best illustrated in FIGS. 1 through 4, the inflatable hunting decoy assembly 10 generally comprises a tree stand 12 that is positionable in a tree 14 for hunting. The tree stand 12 has a platform 16 and a seat 18, and the tree stand 12 may be an archery tree stand of any conventional design. A decoy 20 is provided and the decoy 20 is inflatable. The decoy 20 has a torso 22, a pair of legs 24, a pair of arms 26 and a head 28 such that the decoy 20 has a human appearance. The decoy 20 is positionable in a seated position having the decoy 20 sitting on the seat 18 in the tree stand 12. Thus, the decoy 20 resembles a hunter in a tree stand 12. In this way game proximate the tree 14, such as deer, elk and other hunting game, become accustomed to the sight of a human in the tree stand 12.

A valve 30 is provided and the valve 30 is fluidly coupled to the decoy 20. The valve 30 is positionable in an open position for passing air therethrough. In this way the decoy 20 can be inflated and deflated. The valve 30 is positionable in a closed position to inhibit air from passing therethrough. The valve 30 may be an air valve common to inflatable beach balls, inflatable rafts and or the like. Additionally, the valve 30 may include a cap for closing the valve 30. The decoy 20 may be inflated by breathing into the valve 30 or by fluidly coupling an air pump to the valve 30.

A plurality of tabs 32 is provided and each of the tabs 32 is coupled to and extends away from the decoy 20. Each of the tabs 32 is positioned on a back side 34 of the decoy 20. Additionally, each of the tabs 32 is positioned on a respective one of a first lateral side 36 and a second lateral side 38 of the decoy 20. A plurality of straps 40 is included and each of the straps 40 is removably coupled between a respective one of the tabs 32 and the tree 14 for retaining the decoy 20 on the tree stand 12. The straps 40 may be bungee cords, ratcheting straps and any other type of strap that can be adjusted to a selected length.

A garment 42 is provided for wearing on the decoy 20. The garment 42 has a body 44, a pair of legs 46 and a pair of arms 48. Additionally, the garment 42 is comprised of camouflaged material to give the decoy 20 the ornamental appearance of a hunter. The garment 42 may be a camouflaged hunting suit of any conventional design and appearance. A hat 50 is worn on the head 28 of the decoy 20 and the hat 50 is comprised of a camouflaged material to give the decoy 20 the ornamental appearance of a hunter. A mask 52 is worn on the head 28 of the decoy 20 and the mask 52 is comprised of a camouflaged material to give the decoy 20 the ornament appearance of a hunter. The mask 52 may be a hunting mask of any conventional design and appearance, and the hat 50 may be a hunting hat of any conventional design and appearance.

In use, the tree stand 12 is positioned in a selected tree 14. The decoy 20 is inflated and each of the garment 42, the hat 50 and the mask 52 is positioned on the decoy 20. Additionally, the decoy 20 is positioned in the tree stand 12 to resemble a hunter in the tree stand 12. The straps 40 are wrapped around the tree 14 and attached to respect tabs 32 to retain the decoy 20 in the tree stand 12. The decoy 20 is positioned in the tree stand 12 several months prior to commencement of hunting season. In this way game in the area, such as deer and elk, become accustomed to the sight of a hunter in a tree stand 12. Thus, a real hunter can more successfully hunt in the tree stand 12 during hunting season as the game will be less likely to become alarmed by the sight of the hunter in the tree stand 12. Additionally, the decoy 20 can be seated on the ground or positioned in any conspicuous location that facilitates the decoy 20 to be in sight of the game.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An inflatable hunting decoy assembly being configured to resemble a hunter in a tree, said assembly comprising:
a tree stand being positionable in a tree for hunting, said tree stand having a platform and a seat;
a decoy being positionable in said tree stand, said decoy being structured to resemble a hunter in a tree stand thereby facilitating game proximate said tree stand to become accustomed to the sight of a human in said tree stand;
a garment being worn on said decoy, said garment being comprised of camouflaged material wherein said garment is configured to give said decoy the ornamental appearance of a hunter.

2. The assembly according to claim 1, wherein, said decoy is inflatable, said decoy has a torso, a pair of legs, a pair of arms and a head wherein said decoy is configured to have a human appearance, said decoy being positionable in a seated position having said decoy sitting on said seat in said tree stand.

3. The assembly according to claim 2, further comprising a valve being fluidly coupled to said decoy, said valve being positionable in an open position for passing air therethrough to inflate and deflate said decoy, said valve being positionable in a closed position to inhibit air from passing therethrough.

4. The assembly according to claim 2, further comprising a plurality of tabs, each of said tabs being coupled to and extending away from said decoy, each of said tabs being positioned on a back side of said decoy, each of said tabs being positioned on a respective one of a first lateral side and a second lateral side of said decoy.

5. The assembly according to claim 4, further comprising a plurality of straps, each of said straps being removably coupled between a respective one of said tabs and the tree for retaining said decoy on said tree stand.

6. The assembly according to claim 2, further comprising a hat being worn on said head of said decoy, said hat being comprised of a camouflaged material wherein said hat is configured to give said decoy the ornamental appearance of a hunter.

7. The assembly according to claim 2, further comprising a mask being worn on said head of said decoy, said mask being comprised of a camouflaged material wherein said mask is configured to give said decoy the ornament appearance of a hunter.

8. An inflatable hunting decoy assembly being configured to resemble a hunter in a tree, said assembly comprising:
a tree stand being positionable in a tree for hunting, said tree stand having a platform and a seat;
a decoy being inflatable, said decoy having a torso, a pair of legs, a pair of arms and a head wherein said decoy is configured to have a human appearance, said decoy being positionable in a seated position having said decoy sitting on said seat in said tree stand such that said decoy resembles a hunter in a tree stand thereby facilitating game proximate said tree stand to become accustomed to the sight of a human in said tree stand;
a valve being fluidly coupled to said decoy, said valve being positionable in an open position for passing air therethrough to inflate and deflate said decoy, said valve being positionable in a closed position to inhibit air from passing therethrough;
a plurality of tabs, each of said tabs being coupled to and extending away from said decoy, each of said tabs being positioned on a back side of said decoy, each of said tabs being positioned on a respective one of a first lateral side and a second lateral side of said decoy;
a plurality of straps, each of said straps being removably coupled between a respective one of said tabs and the tree for retaining said decoy on said tree stand;
a garment being worn on said decoy, said garment having a body, a pair of legs and a pair of arms, said garment being comprised of camouflaged material wherein said garment is configured to give said decoy the ornamental appearance of a hunter;
a hat being worn on said head of said decoy, said hat being comprised of a camouflaged material wherein said hat is configured to give said decoy the ornamental appearance of a hunter; and
a mask being worn on said head of said decoy, said mask being comprised of a camouflaged material wherein said mask is configured to give said decoy the ornament appearance of a hunter.
